(19) United States
(12) Patent Application Publication
(10) Pub. No.: US 2005/0152705 A1
(43) Pub. Date: Jul. 14, 2005

(54) Gain variable amplifier, carrier detection system, and infrared remote-control receiver using them

(75) Inventors: Takahiro Inoue, Katsuragi-shi (JP); Noboru Takeuchi, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/034,181

(22) Filed: Jan. 12, 2005

(30) Foreign Application Priority Data
Jan. 13, 2004 (JP) 2004-006011

(51) Int. Cl. H04B 10/06

(52) U.S. Cl. 398/202; 398/106

(57) ABSTRACT

In a gain variable amplifier, a carrier detection circuit system, and an infrared remote-control receiver using the gain variable amplifier or the carrier detection circuit system, to each of a positive output voltage Vo1 and a negative output voltage Vo2 of an amp to be subjected to gain control, connected is an AGC circuit output current (½) Iagc which is one-half of a gain control current and is a constant current. With this arrangement, it is possible to provide the gain variable amplifier, the carrier detection circuit system, both of which can reduce noise superimposed on the gain control current, and it is also possible to provide the infrared remote-control receiver using the gain variable amplifier or the carrier detection circuit system.

This Nonprovisional application claims priority under 35 U.S.C. § 119(a) on Patent Application No. 2004/6011 filed in Japan on Jan. 13, 2004, the entire contents of which are hereby incorporated by reference.

### FIELD OF THE INVENTION

The present invention relates to a gain variable amplifier and a carrier detection system, each of which is preferably used as an optical semiconductor device in, for example, a receiver for an infrared remote controller. The present invention also relates to an infrared remote-control receiver using the gain variable amplifier or the carrier detection system.

### BACKGROUND OF THE INVENTION

Generally, a transmitting signal of an infrared remote-control receiver is an ASK (Amplitude Shift Keying) signal, which is modulated by a carrier having frequency of about 30 kHz to 60 kHz. In a receiving chip, an amp amplifies a photocurrent signal inputted, a band pass filter (BPF), which is adjusted according to a carrier frequency, takes out a carrier component, a wave-detection circuit detects the carrier, an integration circuit performs integration with respect to a time when there exists the carrier, and a hysteresis comparator judges whether or not the carrier exists and outputs a digital signal.

By the way, there exists a carrier component having frequency of 30 kHz to 60 kHz in a home-use inverter fluorescent light. Therefore, when there is an inverter fluorescent light near the infrared remote-control receiver, the infrared remote-control receiver may operate improperly by detecting a noise component of the inverter fluorescent light. In the worst case, the infrared remote-control receiver cannot receive the transmitting signal properly.

To solve this problem, it is effective to provide a carrier detection circuit or a gain variable circuit for AGC (Auto Gain Control) so that a property with respect to disturbance noises is improved.

However, gains of an entire system of the infrared remote-control receiver are high. Therefore, when an output level of the carrier detection circuit is detected so that a gain of an amp section is controlled through an AGC circuit, the signal-receiving property deteriorates under the influence of, for example, power-supply noise superimposed on the output level of the carrier detection circuit.

Furthermore, a cost reduction of the infrared remote-control receiver is strongly demanded. Conventionally, an integration capacitor for a carrier detection circuit was an external chip capacitor (about 0.1 μF). Nowadays, a capacitor (about 100 pF) is commonly contained in an integrated circuit (IC). When the capacitor is contained in the IC, a charge/discharge current becomes on the order of 100 pA. Therefore, impedance of the carrier detection circuit rises, and this causes the infrared remote-control receiver to be susceptible to power-supply noise and the like.

To solve the above problem, FIG. 7 illustrates an example of a receiving system of the infrared remote-control receiver.

In the receiving system of an infrared remote-control receiver 100, a photocurrent signal Iin inputted from a photodiode chip PD is demodulated and outputted by an integrated receiving chip. The output is connected to, for example, a microcomputer which controls an electronic device. It should be noted that this arrangement is common.

The photocurrent signal Iin is an ASK signal which is modulated by a predetermined carrier having frequency of about 30 kHz to 60 kHz. In the infrared remote-control receiver 100 composed of a receiving chip, amps 101, 102 and 103 amplify the photocurrent signal Iin inputted, and a band pass filter (BPF) 104, which is adjusted according to frequency of the carrier, takes out a carrier component, a carrier detection circuit 105, which is a wave-detection circuit, detects the carrier, an integration circuit 106 performs integrations with respect to a time when there exists the carrier, and a hysteresis comparator 107 judges whether or not the carrier exists and outputs a digital signal. Note that, in the above arrangement, an output level of the carrier detection circuit 105 is detected, and a gain of the amp 102 is controlled through an AGC circuit 110. Note that, FIG. 8 illustrates waveforms of respective signals.

FIG. 9 illustrates an example of a conventional arrangement of the AGC circuit 110. That is, the AGC circuit 110, which is a gain variable amplification circuit, varies a bias current of the amp 102 in accordance with a control voltage.

As illustrated in FIG. 9, when an AGC circuit output current Iagc is 0, that is, when the AGC circuit 110 is OFF, an output voltage Vo1 and an output voltage Vo2 from the AMP circuit 120 corresponding to the amp 102 are determined by a conductance gm of a transistor QN1, a conductance gm of a transistor QN2, and output resistors R. The output voltages Vo1 and Vo2 and the conductance gm are expressed by the following equations:

$$\begin{matrix}\begin{matrix}Vo 1 = Vcc - {{R}^{*} ( 1 / 2 )}^{*} I1 - {R}^{*} gm / {2}^{*} ( Vin1 - Vin2 ) \\ = Vcc - {{R}^{*} ( 1 / 2 )}^{*} I1 - {R}^{*} I1 / {( 4 Vt )}^{*} ( Vin1 - Vin2 )\end{matrix} & ( 1 ) ; \\ \begin{matrix}Vo 2 = Vcc - {{R}^{*} ( 1 / 2 )}^{*} I1 + {R}^{*} gm / {2}^{*} ( Vin1 - Vin2 ) \\ = Vcc - {{R}^{*} ( 1 / 2 )}^{*} I1 + {R}^{*} I1 / {( 4 Vt )}^{*} ( Vin1 - Vin2 )\end{matrix} & ( 2 ) ; \\ \begin{matrix}and \\ gm = ( I1 / 2 ) / Vt\end{matrix} & ( 3 )\end{matrix}$$

(where Vt=kT/q, k is Boltzmann's constant, T is absolute temperature, q is elementary charge of electron).

Therefore, a differential voltage gain Av is expressed by the following equation:

$$\begin{matrix}Av = ( Vo1 - Vo2 ) / ( Vin1 - Vin2 ) \\ - {R}^{*} I1 / ( 2 Vt ) .\end{matrix} \qquad ( 4 )$$

Meanwhile, when the AGC circuit output current Iagc is generated by a control voltage Det and the AGC circuit 110 is ON, the output voltages Vo1 and Vo2 and the differential voltage gain Av are expressed by the following equations:
Vo1=Vcc−R*(½)*(I1−Iagc)−R*(I1−Iagc)/(4Vt)*(Vin1−Vin2) (5);
Vo2=Vcc−R*(½)*(I1−Iagc)+R*(I1−Iagc)/(4Vt)*(Vin1−Vin2) (6);
and
Av=−R*(I1−Iagc)/(2Vt) (7)

As a result, the bias current (I1−Iagc) of the AMP circuit 120 is controlled by the AGC circuit output current Iagc, whereby it is possible to vary the gain.

However, in the above arrangement, when noise is superimposed on the AGC circuit output current Iagc, the output voltage Vo1 and the output voltage Vo2 from the AMP circuit 120 are influenced by the noise, according to a second term “R*(½)*(I1−Iagc)” in each of the equations (5) and (6).

In the infrared remote-control receiver 100, generally, a gain of the AMP circuit 120 is controlled in accordance with a control voltage which is an output from the carrier detection circuit 105. FIG. 10 illustrates another conventional arrangement of a gain variable amplifier-carrier detection circuit system.

However, generally, impedance is high in a carrier detection circuit 205, and noise such as power-supply noise is superimposed easily. On this account, in a gain variable amplifier-carrier detection circuit system 200 illustrated in FIG. 10, noise superimposed on a carrier detection circuit output Det is fed back to an amp 202. This causes a noise component (a second term in each of the equations (5) and (6)) shown in the receiving system of the infrared remote-control receiver 100, resulting in property deterioration.

Meanwhile, examples of a detailed arrangement of the carrier detection circuit 205 include: (i) a external-capacitor-type carrier detection circuit 205a illustrated in FIG. 11, and (ii) a capacitor-containing-type carrier detection circuit 205b, which is illustrated in FIG. 12 and is disclosed in Japanese Laid-Open Patent Application No. 51093/2002 (Tokukai 2002-51093, published on Feb. 15, 2002, hereinafter referred to as Patent Document 1).

By the way, in the infrared remote-control receiver, the carrier detection circuit requires a time constant of about 100 msec/0.1V.

In the carrier detection circuit 205a illustrated in FIG. 11, a carrier level (Det) detection capacitor C1 is externally provided, so that its capacity value is about 0.1 μF. Therefore, a charge/discharge current to obtain the time constant of 100 msec/0.1V is on the order of 100 nA.

On the other hand, in the carrier detection circuit 205b disclosed in Patent Document 1, a carrier level (Det) detection capacitor C2 is contained, its capacity value is about 100 pF. Therefore, a charge/discharge current to obtain the time constant of 100 msec/0.1V is on the order of 100 pA.

The time constant t/V is expressed by the following equation:
t/V=C/I (8).

In this case, when the charge/discharge current value is made to be low, impedance of a transistor of a charge/discharge circuit rises, which increases the influence of noise.

As for an input resistance and an output resistance of a single transistor, when a collector current Ic decreases, both a value of the input resistance and a value of the output resistance increase. Input resistance rπ and output resistance ro are expressed by the following equations:
rπ=hfe*Vt/Ic (9); and
ro=Va/Ic (10)
(where Vt=k*T/q, k is Boltzmann's constant, T is absolute temperature, q is elementary charge of electron, and Va is early voltage).

Therefore, for cost reductions, it is common to use a carrier detection circuit with an internal capacitor C. However, in such a circuit, noise superimposed on the carrier detection circuit output Det becomes high, and the noise influences the gain variable amplifier (carrier detection circuit system).

Thus, in the AGC circuit 110 which is the conventional gain variable amplifier illustrated in FIG. 9, when noise is superimposed on the AGC circuit output current Iagc, a gain variable amplifier-carrier detection circuit system is influenced by the noise.

Moreover, in the gain variable amplifier-carrier detection circuit system 200 illustrated in FIG. 10, when noise is superimposed on the AGC circuit output current Iagc, the gain variable amplifier-carrier detection circuit system 200 is influenced by the noise. Especially in case of the carrier detection circuit with the internal capacitor C, the influence of noise becomes great.

### SUMMARY OF THE INVENTION

An object of the present invention is to provide a gain variable amplifier, a carrier detection system, both of which can reduce noise superimposed on a gain control current, and is to provide an infrared remote-control receiver using the gain variable amplifier or the carrier detection system.

To achieve the above object, a gain variable amplifier of the present invention is a gain variable amplifier which varies a bias current of an amp in accordance with a control voltage, wherein, to positive and negative outputs of the amp to be subjected to gain control, current sources are respectively connected, each of the current sources supplying a current which is one-half of a gain control current.

According to the present invention, the current source for supplying the current which is one-half of the gain control current is provided at each of output stages of the gain variable amplifier, so that it is possible to reduce the noise superimposed on the gain control current.

Therefore, it is possible to provide the gain variable amplifier which makes it possible to reduce the noise superimposed on the gain control current.

Moreover, to achieve the above object, the carrier detection system of the present invention is a carrier detection system including a filter circuit, a carrier detection circuit, and a gain variable amplifier, wherein an output level of the carrier detection circuit is detected so that a gain of an amp circuit provided in the gain variable amplifier is controlled, wherein, to positive and negative outputs of the amp circuit to be subjected to gain control, current sources are respectively connected, each of the current sources supplying a current which is one-half of a gain control current.

According to the above invention, the current source for supplying the current which is one-half of the gain control current is provided to each of the positive and negative outputs of the amp circuit to be subjected to gain control, so that it is possible to reduce the noise superimposed on the gain control current.

Therefore, it is possible to provide the carrier detection system which makes it possible to reduce the noise superimposed on the gain control current.

Furthermore, in the above-described carrier detection system, the carrier detection system of the present invention is arranged such that the amp circuit includes two amps to be subjected to gain control. Moreover, to the positive and negative outputs of each of the amps, current sources are respectively connected, each of the current sources supplying a current which is one-half of the gain control current.

According to the above invention, two amps to be subjected to gain control are provided, and to the positive and negative outputs of each of the amps, current sources are respectively connected, each of the current sources supplying a current which is one-half of the gain control current. Therefore, it is possible to reduce the noise superimposed on the gain control current.

In addition, in the present invention, the two amps to be subjected to gain control are provided, so that it is possible to increase the range of a gain to be controlled.

Moreover, in the above-described carrier detection system, the carrier detection system of the present invention is arranged such that a capacitor is contained in an integrated circuit.

That is, in the carrier detection system using the carrier detection circuit in which the capacitor is contained in the integrated circuit, the capacitor is small in capacity, so that impedance of a transistor of a charge/discharge circuit rises, which increases the influence of the noise.

To solve the problem, in the carrier detection system of the present invention, when using the carrier detection circuit in which the capacitor is contained in the integrated circuit, to each of positive and negative outputs of the amp to be subjected to gain control, connected is a current source for supplying a current which is one-half of the gain control current.

Therefore, in the carrier detection circuit in which the capacitor is contained in the integrated circuit, it is possible to reduce the noise superimposed on the gain control current, and this produces a great effect.

In addition, the infrared remote-control receiver of the present invention is arranged such that the above-described gain variable amplifier is used therein.

Moreover, the infrared remote-control receiver of the present invention is arranged such that the above-described carrier detection system is used therein.

Therefore, it is possible to provide the infrared remote-control receiver using the gain variable amplifier or using the carrier detection system, both of which can reduce the noise superimposed on the gain control current.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating one embodiment of an infrared remote-control receiver according to the present invention.

FIG. 2 is a block diagram illustrating an arrangement of a gain variable amplification circuit in the infrared remote-control receiver.

FIG. 3 is a block diagram illustrating an arrangement of a carrier detection circuit system in the infrared remote-control receiver.

FIG. 4 is a block diagram illustrating an arrangement of a carrier detection circuit system including two amps.

FIG. 5 is a block diagram illustrating an arrangement of a gain variable amplification circuit including the two amps.

FIG. 6 is a block diagram illustrating an arrangement of an infrared remote-control receiver including the two amps.

FIG. 7 is a block diagram illustrating a receiving system of a conventional infrared remote-control receiver.

FIG. 8 is a diagram illustrating waveforms of output signals in the infrared remote-control receiver.

FIG. 9 is a block diagram illustrating an arrangement of a gain variable amplification circuit in the infrared remote-control receiver.

FIG. 10 is a block diagram illustrating an arrangement of a carrier detection circuit system in the infrared remote-control receiver.

FIG. 11 is a circuit diagram illustrating an arrangement of an external-capacitor-type carrier detection circuit in the infrared remote-control receiver.

FIG. 12 is a circuit diagram illustrating an arrangement of a capacitor-containing-type carrier detection circuit in the infrared remote-control receiver.

### DESCRIPTION OF THE EMBODIMENTS

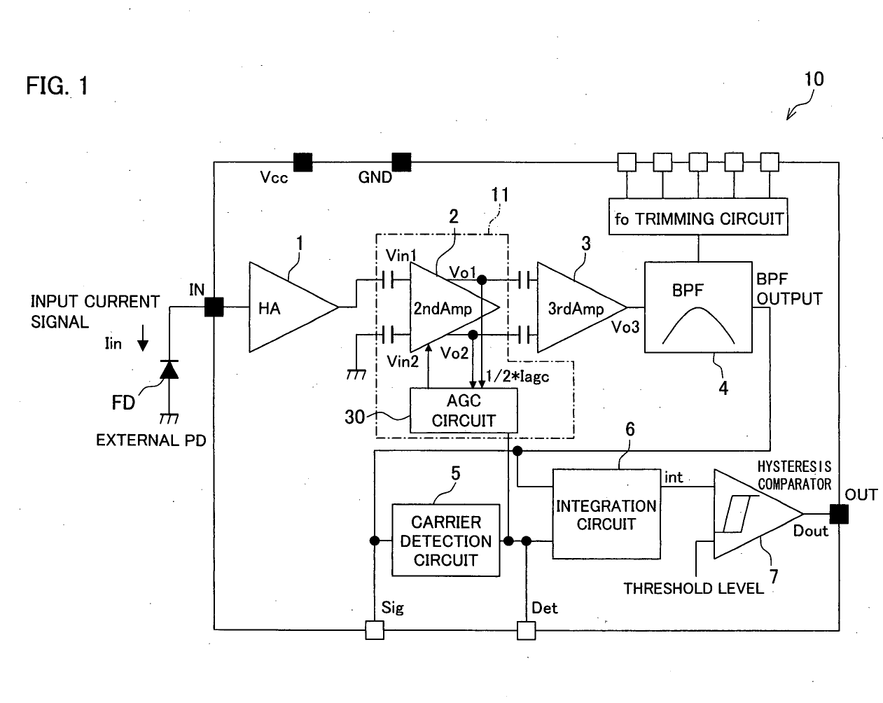

The following description explains one embodiment of the present invention with reference to FIGS. 1 to 6.

As illustrated in FIG. 1, an infrared remote-control receiver 10 of the present embodiment includes a photodiode chip PD, amps 1, 2 and 3, a band pass filter (BPF) 4 as a filter circuit, a carrier detection circuit 5, an integration circuit 6, a hysteresis comparator 7, and the like. The amps 1, 2 and 3, the band pass filter (BPF) 4, the carrier detection circuit 5, the integration circuit 6, the hysteresis comparator 7, and the like are integrated in a receiving chip.

In the infrared remote-control receiver 10, a photocurrent signal Iin inputted from the photodiode chip PD is demodulated and outputted by the integrated receiving chip. The output is connected to, for example, a microcomputer which controls an electronic device (not illustrated).

The photocurrent signal Iin is an ASK (Amplitude Shift Keying) signal which is modulated by a predetermined carrier having frequency of about 30 kHz to 60 kHz.

In the receiving chip, the amps 1, 2 and 3 amplify the photocurrent signal Iin inputted, the band pass filter (BPF) 4, which is adjusted according to the frequency of the carrier, takes out a carrier component, the carrier detection circuit 5, which is a wave-detection circuit, detects the carrier, the integration circuit 6 performs integration with respect to a time when there exists the carrier, and the hysteresis comparator 7 judges whether or not the carrier exists and outputs a digital signal. Note that, in the above arrangement, an output level of the carrier detection circuit 5 is detected, and a gain of the amp 2 is controlled through an AGC (Auto Gain Control) circuit 30.

As illustrated in FIG. 1, in the present embodiment, the amp 2 and the AGC circuit 30 constitutes a gain variable amplification circuit 11 as a gain variable amplifier which varies a bias current of an amp by a control voltage.

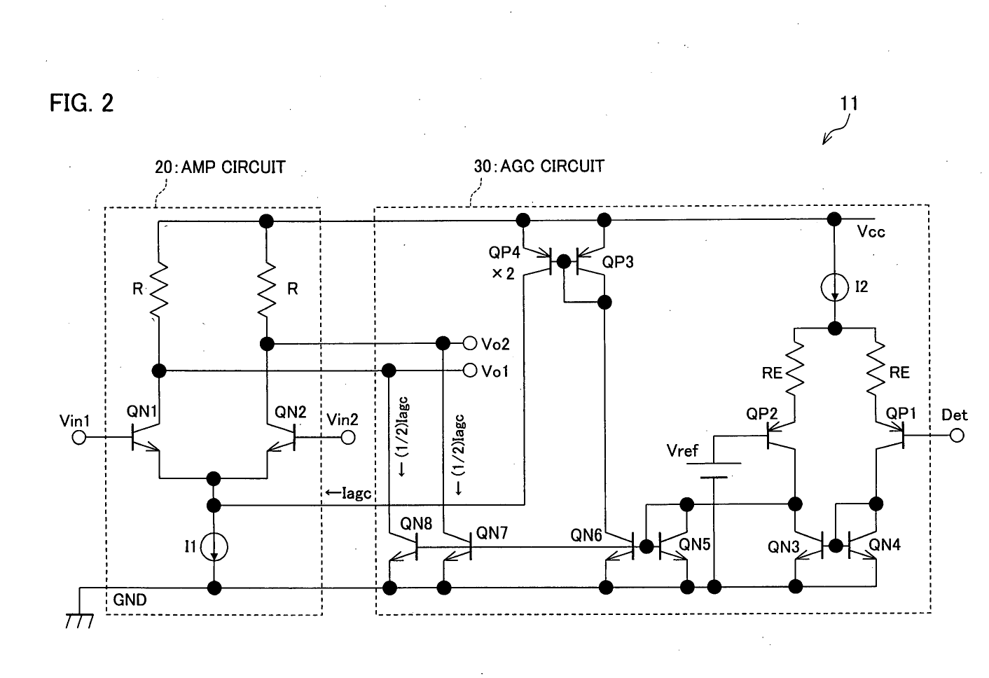

Specifically, the amp 2 is illustrated in FIG. 2 as an AMP circuit section 20. The AMP circuit section 20 includes transistors QN1 and QN2, and two output resistors R.

More specifically, the AMP circuit section 20 includes the transistors QN1 and QN2 and a constant-current generator I1. The transistors QN1 and QN2 constitute a differential pair, and the constant-current generator I1 is connected to emitters, which are connected to each other, of the transistors QN1 and QN2. Note that, to collectors of the transistors QN1 and QN2, a power supply voltage Vcc is applied through the respective output resistors R. Moreover, to a contact of the constant-current generator I1 and the transistors QN1 and QN2, an output current Iagc is supplied from the AGC circuit 30. Furthermore, the collectors of the transistors QN1 and QN2 are respectively connected to current sources each of which supplies one-half of the output current Iagc (In FIG. 2, the transistor QN1 is connected to a transistor QN8, and the transistor QN2 is connected to a transistor QN7. The transistors Q7 and Q8 will be described later.).

In the gain variable amplification circuit 11, when an AGC circuit output current Iagc is 0, that is, when the AGC circuit 30 is OFF, an output voltage Vo1 and an output voltage Vo2 from the AMP circuit section 20 are determined by a conductance gm of the transistor QN1, a conductance gm of the transistor QN2, and output resistors R. The output voltages Vo1 and Vo2 and the conductance gm are expressed by the following equations:

$$\begin{matrix}\begin{matrix}Vo 1 = Vcc - {{R}^{*} ( 1 / 2 )}^{*} I1 - {R}^{*} gm / {2}^{*} ( Vin1 - Vin2 ) \\ = Vcc - {{R}^{*} ( 1 / 2 )}^{*} I1 - {R}^{*} I1 / {( 4 Vt )}^{*} ( Vin1 - Vin2 )\end{matrix} & ( 11 ) ; \\ \begin{matrix}Vo 2 = Vcc - {{R}^{*} ( 1 / 2 )}^{*} I1 + {R}^{*} gm / {2}^{*} ( Vin1 - Vin2 ) \\ = Vcc - {{R}^{*} ( 1 / 2 )}^{*} I1 + {R}^{*} I1 / {( 4 Vt )}^{*} ( Vin1 - Vin2 )\end{matrix} & ( 12 ) ; \\ \begin{matrix}and \\ gm = ( I1 / 2 ) / Vt\end{matrix} & ( 13 )\end{matrix}$$

(where Vt=kT/q, k: Boltzmann's constant, T: absolute temperature, q: elementary charge of electron).

Therefore, a differential voltage gain Av is expressed by the following equation:

$$\begin{matrix}Av = ( Vo1 - Vo2 ) / ( Vin1 - Vin2 ) \\ - {R}^{*} I1 / ( 2 Vt ) .\end{matrix} \qquad ( 14 )$$

Meanwhile, when the AGC circuit output current Iagc is generated by a control voltage Vdet which is a carrier detection circuit output Det from the carrier detection circuit 5, and the AGC circuit 30 is ON, the output voltages Vo1 and Vo2 are expressed by the following equations:

$$\begin{matrix}\begin{matrix}Vo 1 = Vcc - {{R}^{*} ( 1 / 2 )}^{*} ( I1 \text{-} Iagc ) + {{R}^{*} ( 1 / 2 )}^{*} ( Iagc ) - \\ {R}^{*} ( I1 \text{-} Iagc ) / {( 4 Vt )}^{*} ( Vin1 - Vin2 ) \\ = Vcc - {{R}^{*} ( 1 / 2 )}^{*} ( I1 ) - {R}^{*} ( I1 \text{-} Iagc ) / {( 4 Vt )}^{*} ( Vin1 - Vin2 )\end{matrix} & ( 15 ) ; \\ and & \\ \begin{matrix}Vo 2 = Vcc - {{R}^{*} ( 1 / 2 )}^{*} ( I1 \text{-} Iagc ) + {{R}^{*} ( 1 / 2 )}^{*} ( Iagc ) + \\ {R}^{*} ( I1 \text{-} Iagc ) / {( 4 Vt )}^{*} ( Vin1 - Vin2 ) \\ = Vcc - {{R}^{*} ( 1 / 2 )}^{*} ( I1 ) + {R}^{*} ( I1 \text{-} Iagc ) / {( 4 Vt )}^{*} ( Vin1 - Vin2 ) .\end{matrix} & ( 16 )\end{matrix}$$

Therefore, the differential voltage gain Av is expressed by the following equation:

$$\begin{matrix}Av = ( Vo1 - Vo2 ) / ( Vin1 - Vin2 ) \\ = - {R}^{*} ( I1 \text{-} Iagc ) / ( 2 Vt ) .\end{matrix} \qquad ( 17 )$$

According to the above, the bias current (I1−Iagc) of the AMP circuit section 20 is controlled by the AGC circuit output current Iagc, whereby it is possible to vary the gain.

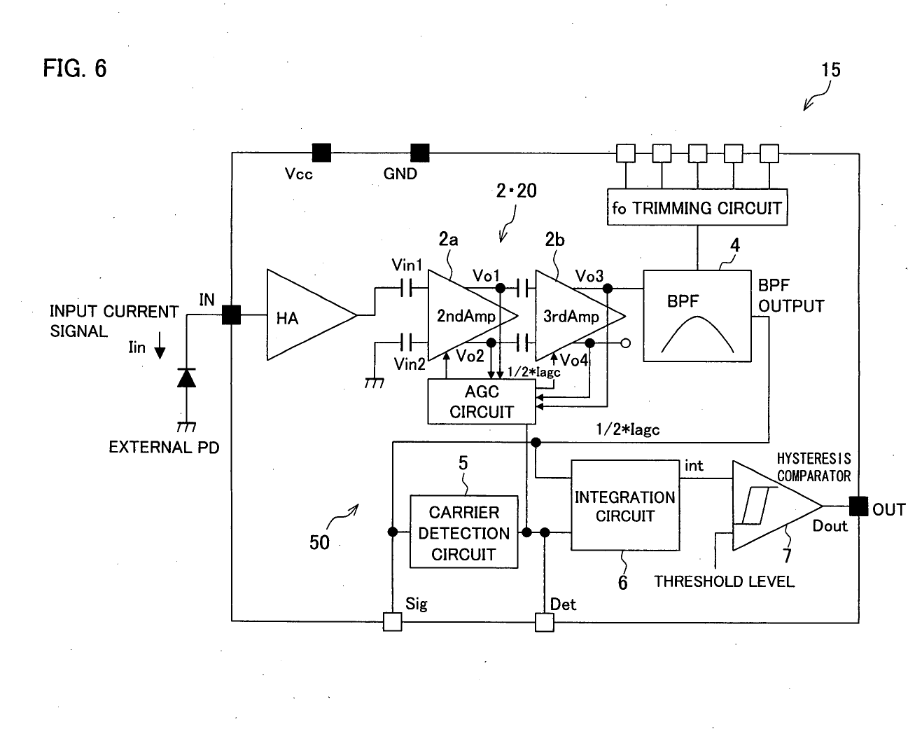

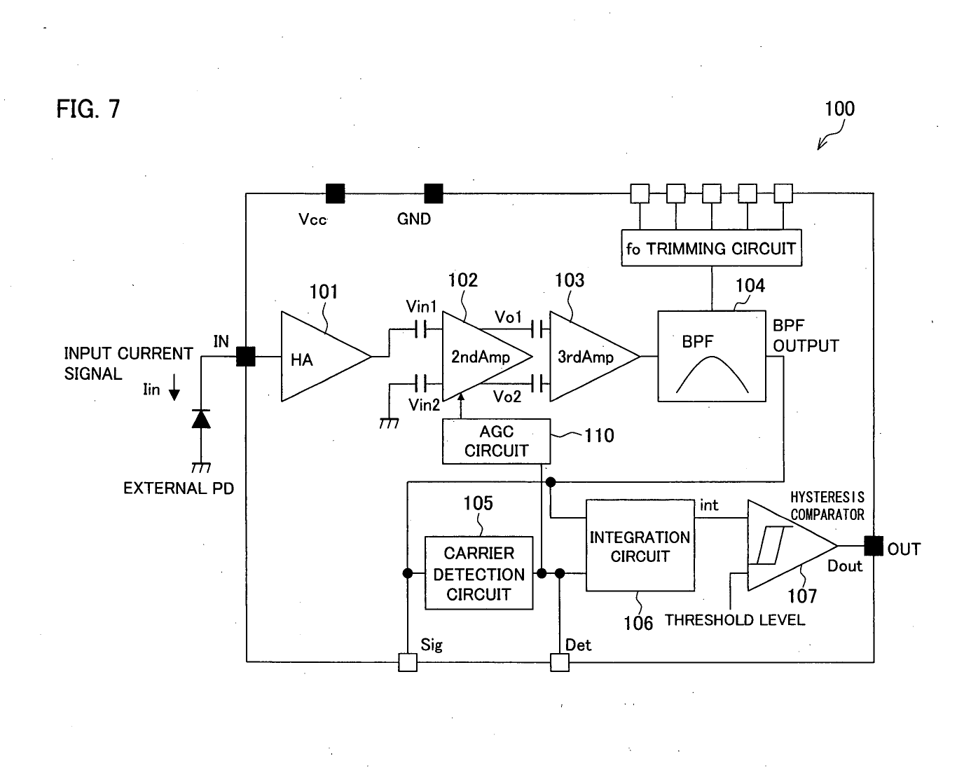

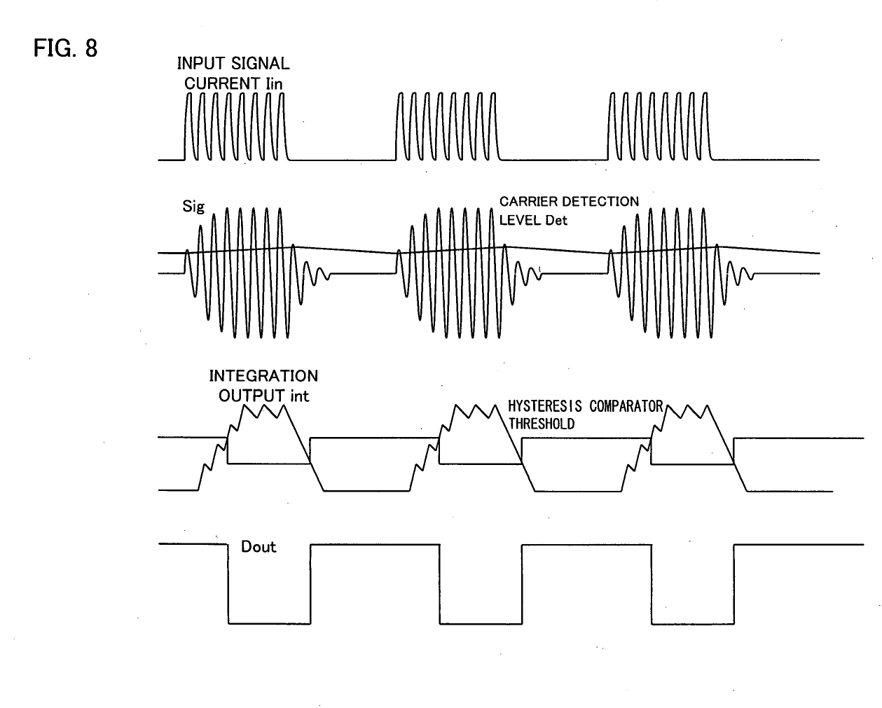

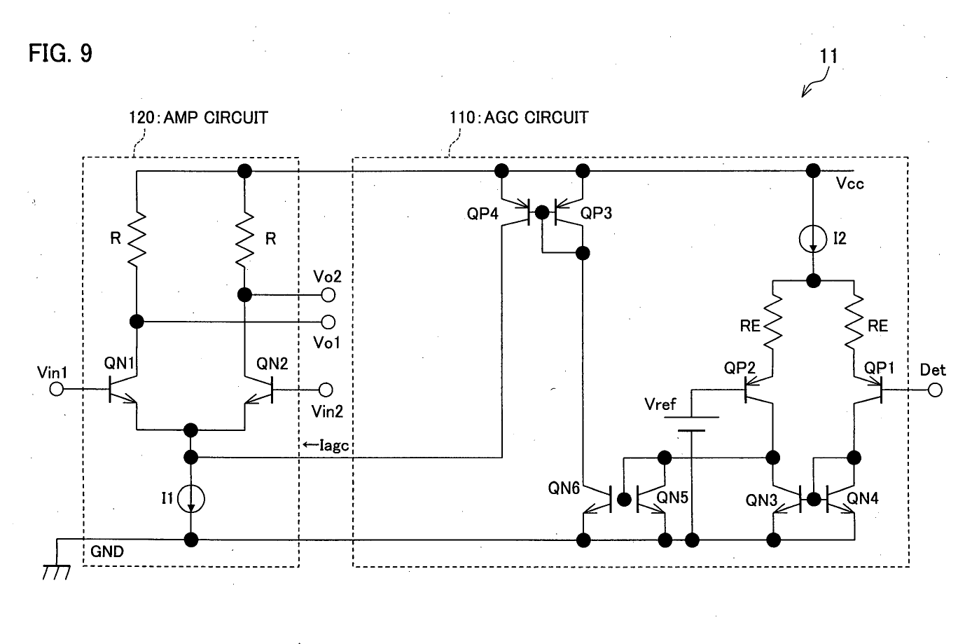

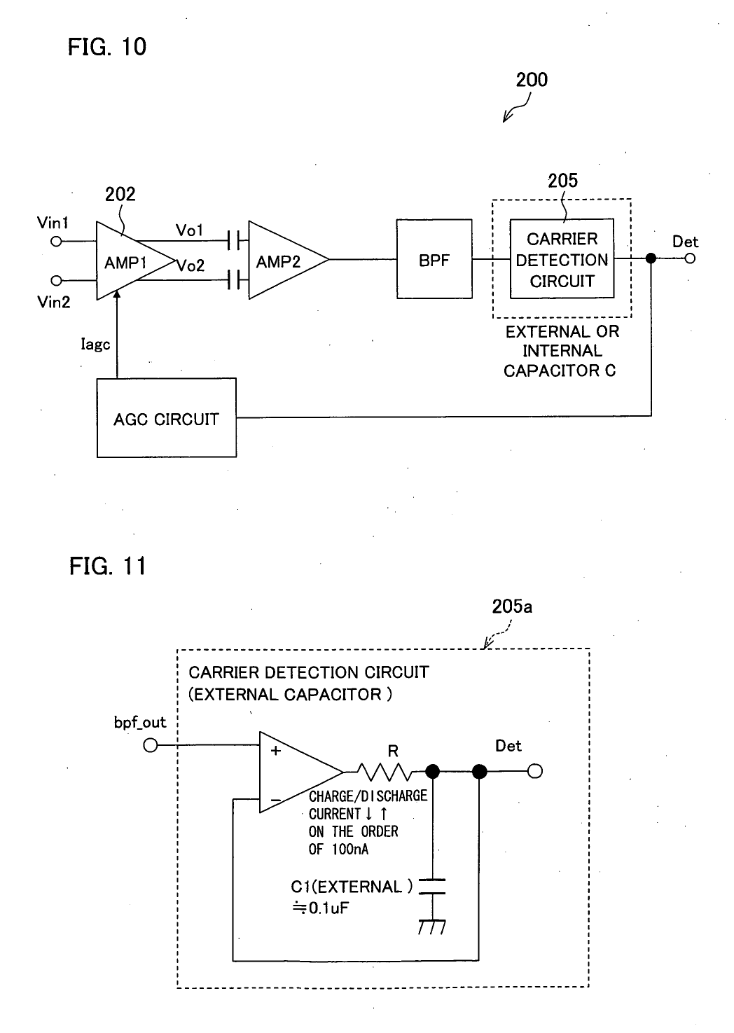

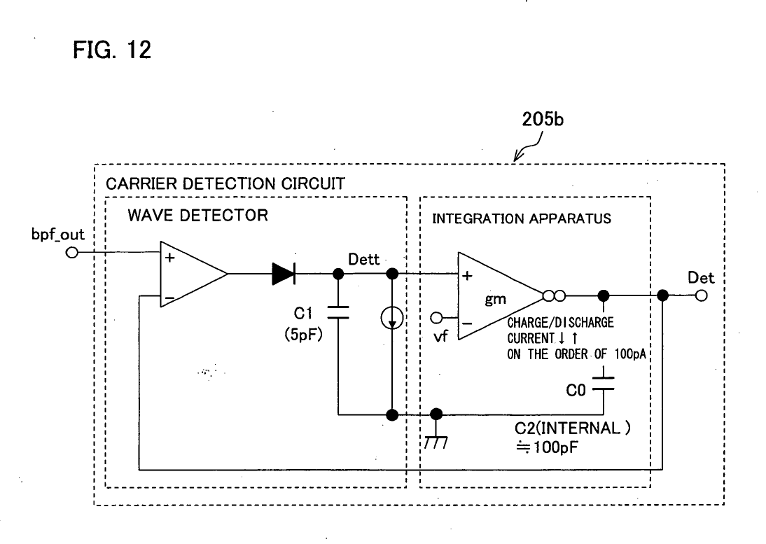

Further, in the present embodiment, a component of the AGC circuit output current Iagc in a second term in each of the equations (5) and (6), which was the problem in the conventional receiving chip illustrated in FIG. 6, can be canceled. Therefore, even when noise is superimposed on the AGC circuit output current Iagc, it is possible to reduce the influence of the noise.

That is, in each of the equations (15) and (16), “+R*(½)*(Iagc)” is added as a third term. As a result of this, when the third term is added to the second term “−R*(½)*(I1−Iagc)” in each of the equations (15) and (16), only “R*(½)*I1” remains. The AGC circuit output current Iagc does not appear in this value, so that the output voltage Vo1 and the output voltage Vo2 from the AMP circuit section 20 are not influenced by the AGC circuit output current Iagc.

The following descriptions explain an arrangement of the AGC circuit 30 which adds “½*Iagc” to the output voltage Vo1 and the output voltage Vo2 from the AMP circuit section 20.

As illustrated in FIG. 2, in the AGC circuit 30 of the present embodiment, a constant-current generator 12, transistors QP1, QP2, QN3, and QN4, and output resistors RE constitute a transconductance amp, and a current corresponding to the control voltage Vdet which is the carrier detection circuit output Det, that is, ½*Iagc is outputted. Moreover, transistors QN5 to QN8 constitute a current mirror circuit, and a current of (½)*Iagc is outputted to a collector of the transistor QN7 and to a collector of the transistor QN8. Furthermore, transistors QP3 and QP4 constitute another current mirror circuit. The emitter of the transistor QP4 is made to be twice as large as that of the transistor QP3 in size, so that the transistor QP4 outputs the AGC circuit output current Iagc.

This is shown by the following equation:
(½)*Iagc=gm*(Vdet−Vref).
(where gm (transconductance)=1/(2*RE+4Vt/I2), Vt=kT/q, k is Boltzmann's constant, T is absolute temperature, and q is: elementary charge of electron).

As a result, a current obtained by the following equation is outputted according to the voltage (Vdet), and auto gain control is carried out:
(½)*Iagc=(Vdet−Vref)/(2*RE+4Vt/I2).

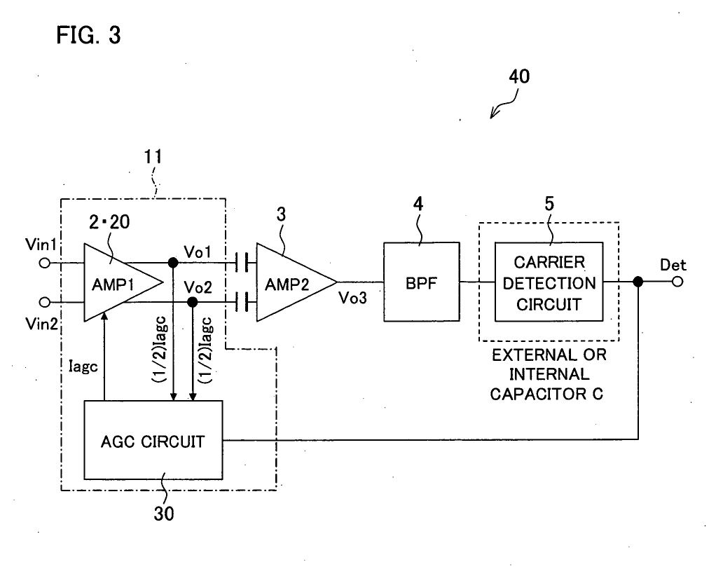

The above description has explained the gain variable amplification circuit 11 composed of the AMP circuit section 20 and the AGC circuit 30. Next, as illustrated in FIG. 3, the carrier detection circuit 5 is added to the gain variable amplification circuit 11, so that a carrier detection circuit system 40 can be constituted.

That is, similarly, in the carrier detection circuit system 40, a current source for supplying a noise-canceling current is provided at each of output stages of the amp 2. The noise-canceling current is one-half of the AGC circuit output current Iagc.

With this arrangement, it is possible to reduce the influence of the noise superimposed on the output of the carrier detection circuit 5, and also possible to improve properties of the carrier detection circuit system 40.

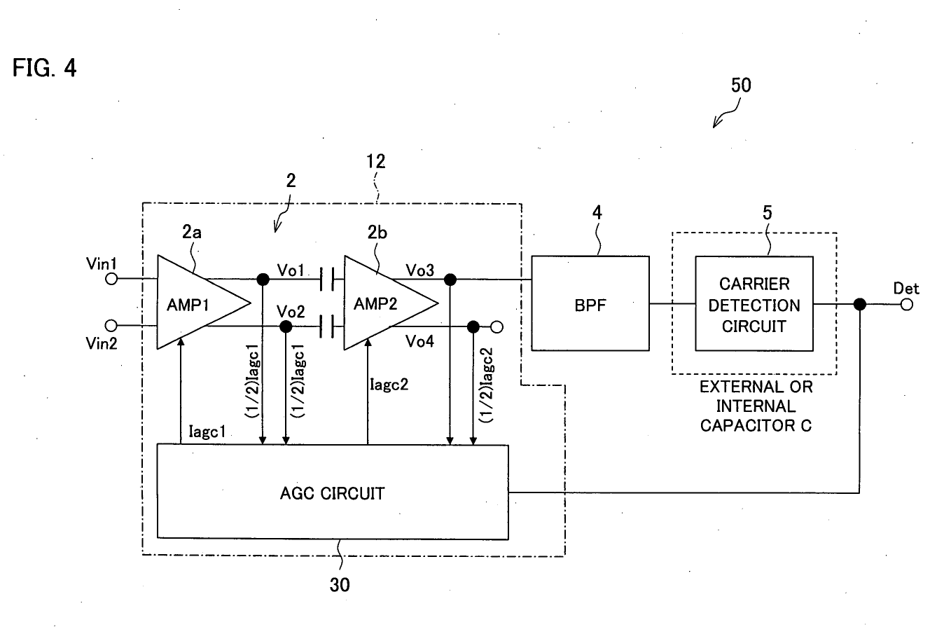

Note that, in the foregoing description, the number of the amp 2 is one; however, the present invention is not limited to this. As illustrated in FIG. 4, it is possible to provide a carrier detection circuit system 50 including a carrier detection circuit 5 and a gain variable amplification circuit 12 which performs gain control with respect to two amps 2a and 2b which are respectively an amp in a first stage and an amp in a following stage, unlike the carrier detection circuit system 40.

In the carrier detection circuit system 50, a gain of 15 dB to 20 dB can be controlled for one amp, so that a gain of 30 dB to 40 dB can be controlled for two amps 2a and 2b. In addition, a current source for supplying a noise-canceling current is provided at each of the output stages of the two amps, so that it is possible to reduce the influence of the noise. The current source for supplying a noise-canceling current is a (½) AGC circuit output current Iagc1 or a (½) AGC circuit output current Iagc2.

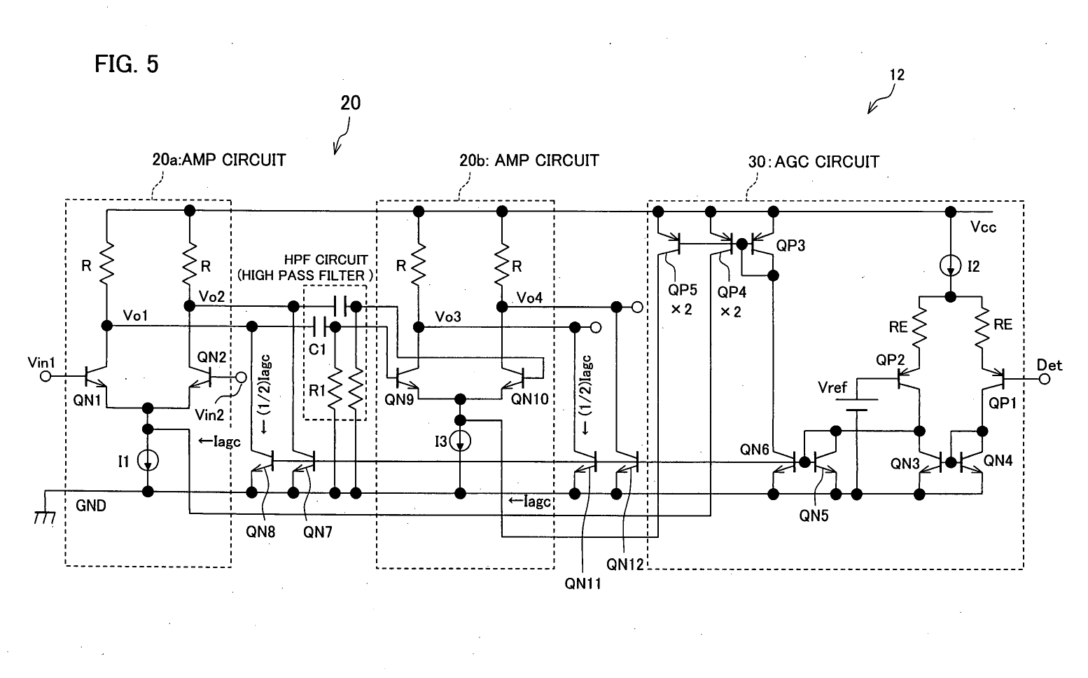

FIG. 5 illustrates the gain variable amplification circuit 12 in detail. FIG. 6 illustrates an infrared remote-control receiver 15 including the carrier detection circuit system 50 described above.

As described above, in the gain variable amplification circuit 11 of the present embodiment, the bias current of the amp 2 or the bias current of the AMP circuit section 20 is varied in accordance with the control voltage Vdet, which is the carrier detection circuit output Det. To each of a positive voltage Vo1 and a negative output voltage Vo2 of the amp 2 or the AMP circuit section 20 to be subjected to gain control, connected is an AGC circuit output current (½) Iagc which is one-half of a gain control current.

Therefore, it is possible to reduce the noise superimposed on the gain control current, that is, the noise superimposed on the control voltage Vdet.

As a result, it is possible to provide the gain variable amplification circuit 11 which makes it possible to reduce the noise superimposed on the gain control current.

The carrier detection circuit system 40 of the present embodiment includes the amp 2 or the AMP circuit section 20, the band pass filter (BPF) 4, the carrier detection circuit 5, and the gain variable amplification circuit 11. Moreover, the carrier detection circuit output Det, which is the output level of the carrier detection circuit 5, is detected, and the gain of the amp circuit is controlled through the gain variable amplification circuit 11. Then, to each of the positive and negative outputs of the amp 2 or the AMP circuit section 20 to be subjected to gain control, connected is an AGC circuit output current (½) Iagc which is one-half of the gain control current and is a constant current.

Therefore, it is possible to reduce the noise superimposed on the gain control current, that is, the noise superimposed on the carrier detection circuit output Det.

As a result, it is possible to provide the carrier detection circuit system 40 which makes it possible to reduce the noise superimposed on the gain control current.

In the carrier detection circuit system 50 of the present embodiment, the amp 2 in the gain variable amplification circuit 12 includes the amps 2a and 2b whose gains are controlled, or the AMP circuit section 20 in the gain variable amplification circuit 12 includes the AMP circuits 20a and 20b whose gains are controlled. Moreover, to each of respective positive and negative outputs of the amp 2a and the amp 2b, or to each of the respective positive and negative outputs of the AMP circuit 20a and the AMP circuit 20b, connected is an AGC circuit output current (½) Iagc which is one-half of the gain control current and is a constant current.

Therefore, it is possible to reduce the noise superimposed on the gain control current, that is, the noise superimposed on the carrier detection circuit output Det.

As a result, it is possible to provide the carrier detection circuit system 50 which makes it possible to reduce the noise superimposed on the gain control current.

Moreover, according to the present embodiment, the two amps 2a and 2b whose gains are controlled or the two AMP circuits 20a and 20b whose gains are controlled are provided, so that it is possible to increase the range of gains to be controlled.

By the way, in the carrier detection circuit systems 40 and 50 each of which uses the carrier detection circuit 5 containing a capacitor in an integrated circuit, the capacitor is small in capacity, so that impedance of a transistor of a charge/discharge circuit rises, which increases the influence of the noise.

In the carrier detection circuit systems 40 and 50 of the present embodiment, when using the carrier detection circuit 5 containing the capacitor in the integrated circuit, to each of positive and negative outputs of the amp to be subjected to gain control, connected is an AGC circuit output current (½) Iagc which is one-half of the gain control current and is the constant current.

Therefore, when using the carrier detection circuit 5 containing the capacitor in the integrated circuit, it is possible to reduce the noise superimposed on the gain control current, and this produces a great effect.

Moreover, the infrared remote-control receiver 10 of the present embodiment uses the gain variable amplification circuit 11, and the infrared remote-control receiver 15 of the present embodiment uses the gain variable amplification circuit 12.

Furthermore, the infrared remote-control receiver 10 of the present embodiment uses the carrier detection circuit system 40, and the infrared remote-control receiver 15 of the present embodiment uses the carrier detection circuit system 50.

Therefore, it is possible to provide the infrared remote-control receiver 10 using the gain variable amplification circuit 11, the infrared remote-control receiver 15 using the gain variable amplification circuit 12, the infrared remote-control receiver 10 using the carrier detection circuit system 40, and the infrared remote-control receivers 15 using the carrier detection circuit system 50, each of which makes it possible to reduce the noise superimposed on the gain control current.

As described above, a gain variable amplifier (for example, 11 and 12) of the present invention is a gain valuable amplifier which varies a bias current of an amp in accordance with a control voltage, to positive and negative outputs of the amp (for example, 2, 2a, 2b, 20, 20a, and 20b) to be subjected to gain control, current sources (for example, QN7, QN8, QN11, and QN12) are respectively connected, each of the current sources supplying a current which is one-half of a gain control current.

According to the present invention, the current source for supplying the current which is ½ of the gain control current is provided at each of output stages of the gain variable amplifier, so that it is possible to reduce the noise superimposed on the gain control current.

Therefore, it is possible to provide the gain variable amplifier which makes it possible to reduce the noise superimposed on the gain control current.

Moreover, as described above, the carrier detection system (for example, 40 and 50) of the present invention includes a filter circuit (for example, BPF4), a carrier detection circuit (for example, 5), and a gain variable amplifier (for example, 11 and 12), wherein an output level of the carrier detection circuit is detected so that a gain of an amp circuit (for example, 2, 2a, 2b, 20a, and 20b) provided in the gain variable amplifier is controlled, wherein, to positive and negative outputs of the amp circuit to be subjected to gain control, current sources are respectively connected, each of the current sources supplying a current which is one-half of a gain control current.

According to the above invention, the current source for supplying the current which is one-half of the gain control current is provided to each of the positive and negative outputs of the amp circuit to be subjected to gain control, so that it is possible to reduce the noise superimposed on the gain control current.

Therefore, it is possible to provide the carrier detection circuit system which makes it possible to reduce the noise superimposed on the gain control current.

Furthermore, in the above-described carrier detection system, the carrier detection system of the present invention is arranged such that the amp circuit includes two amps to be subjected to gain control. Moreover, to the positive and negative outputs of each of the amps, current sources are respectively connected, each of the current sources supplying a current which is one-half of the gain control current.

According to the above invention, two amps to be subjected to gain control are provided, and to the positive and negative outputs of each of the amps, current sources are respectively connected, each of the current sources supplying a current which is one-half of the gain control current. Therefore, it is possible to reduce the noise superimposed on the gain control current.

In addition, in the present invention, the two amps to be subjected to gain control are provided, so that it is possible to increase the range of a gain to be controlled.

Moreover, in the above-described carrier detection system, the carrier detection system of the present invention is arranged such that a capacitor is contained in an integrated circuit.

That is, in the carrier detection circuit system using the carrier detection circuit in which the capacitor is contained in the integrated circuit, the capacitor is small in capacity, so that impedance of a transistor of a charge/discharge circuit rises, which increases the influence of the noise.

To solve the problem, in the carrier detection system of the present invention, when using the carrier detection circuit in which the capacitor is contained in the integrated circuit, to each of positive and negative outputs of the amp to be subjected to gain control, connected is a current source for supplying a current which is one-half of the gain control current.

Therefore, in the carrier detection circuit in which the capacitor is contained in the integrated circuit, it is possible to reduce the noise superimposed on the gain control current, and this produces a great effect.

In addition, the infrared remote-control receiver (for example, 10 and 15) of the present invention is arranged such that the above-described gain variable amplifier is used therein.

Moreover, the infrared remote-control receiver of the present invention is arranged such that the above-described carrier detection system is used therein.

Therefore, it is possible to provide the infrared remote-control receiver using the gain variable amplifier or using the carrier detection system, both of which can reduce the noise superimposed on the gain control current.

According to the present invention, to the positive and negative outputs of the amp to be subjected to gain control, current sources are respectively connected, each of the current sources supplying a current which is one-half of a gain control current, so that it is possible to provide the gain variable amplifier and the carrier detection system, both of which can reduce the noise superimposed on the gain control current, and it is also possible to provide the infrared remote-control receiver using the gain variable amplifier or the carrier detection system.

The present invention is applicable to a gain variable amplifier and a carrier detection circuit system, each of which is preferably used as an optical semiconductor device in a receiver for an infrared remote controller, and the present invention is also applicable to an infrared remote-control receiver using the gain variable amplifier or the carrier detection circuit system.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A gain variable amplifier which varies a bias current of an amp in accordance with a control voltage, wherein
to positive and negative outputs of the amp to be subjected to gain control, current sources are respectively connected, each of the current sources supplying a current which is one-half of a gain control current.

2. The gain variable amplifier as set forth in claim 1, wherein
the amp includes:
transistors constituting a differential pair; and
a constant-current generator being connected to emitters of the transistors, the emitters being connected to each other,
the gain control current is supplied to a contact of the constant-current generator and the transistors, and
the current sources are respectively connected to collectors of the transistors.

3. An infrared remote-control receiver comprising:
a gain variable amplifier which varies a bias current of an amp in accordance with a control voltage, wherein
to positive and negative outputs of the amp to be subjected to gain control, current sources are respectively connected each of the current sources supplying a current which is one-half of a gain control current.

4. A carrier detection system including a filter circuit, a carrier detection circuit, and a gain variable amplifier, wherein an output level of the carrier detection circuit is detected so that a gain of an amp circuit provided in the gain variable amplifier is controlled, wherein
to positive and negative outputs of the amp circuit to be subjected to gain control, current sources are respectively connected, each of the current sources supplying a current which is one-half of a gain control current.

5. The carrier detection system as set forth in claim 4, wherein
the amp circuit includes two amps to be subjected to gain control, and
to the positive and negative outputs of each of the amps, current sources are respectively connected, each of the current sources supplying a current which is one-half of the gain control current.

6. The carrier detection system as set forth in claim 5, wherein
the carrier detection circuit contains a capacitor in an integrated circuit.

7. The carrier detection system as set forth in claim 4, wherein
the carrier detection circuit contains a capacitor in an integrated circuit.

8. An infrared remote-control receiver comprising:
a carrier detection system including a filter circuit, a carrier detection circuit, and a gain variable amplifier, wherein
an output level of the carrier detection circuit is detected so that a gain of an amp circuit provided in the gain variable amplifier is controlled, and
to positive and negative outputs of the amp circuit to be subjected to gain control, current sources are respectively connected, each of the current sources supplying a current which is one-half of a gain control current.

9. The infrared remote-control receiver as set forth in claim 8, wherein
the amp circuit includes two amps to be subjected to gain control, and
to the positive and negative outputs of each of the amps, current sources are respectively connected, each of the current sources supplying a current which is one-half of the gain control current.

10. The infrared remote-control receiver as set forth in claim 8, wherein
the carrier detection circuit contains a capacitor in an integrated circuit.
